(19) United States
(12) Patent Application Publication
(10) Pub. No.: US 2011/0104346 A1
(43) Pub. Date: May 5, 2011

(54) SYSTEMS AND METHODS FOR SEASONING MEAT

(75) Inventors: Cloyd D. Bowsman, Honey Grove, PA (US); Israel Weiss, Brooklyn, NY (US)

(73) Assignee: Baupost Group LLC

(21) Appl. No.: 12/612,164

(22) Filed: Nov. 4, 2009

(51) Int. Cl. A23L 1/318; A23L 1/315; B23Q 15/00

(52) U.S. Cl. 426/295; 99/486

(57) ABSTRACT

The systems and methods described herein relate to automatically seasoning meat. In particular, the systems include a seasoning dispenser positioned over a moving conveyor. The conveyor is coupled to a partially perforated drum having agitator structures. The rotatable drum is coupled with a seasoning collector and a return conveyor, which in turn is coupled back to the seasoning dispenser. During operation, the seasoning dispenser dispenses seasoning into the cavities of meat that are disposed along the conveyor. The seasoning-filled meat falls into the rotatable drum and tumbles about while striking the agitator structures and the walls of the drum, thereby distributing the seasoning across interior and exterior surfaces of the meat. Excess seasoning is collected through the perforations in the drum by the seasoning collector and returned to the seasoning dispenser by the return conveyor for re-use.

### FIELD OF THE INVENTION

This invention relates generally to systems and methods for seasoning meat. More particularly, the invention relates to systems and methods for automatically seasoning the interior and exterior surfaces of poultry.

### BACKGROUND

Kosher poultry, such as chickens, are typically prepared using an assembly line approach. In various conventional approaches, after the poultry are slaughtered, they are shackled onto trolleys by their legs and hung from a conveyor line so that they can move throughout the plant for processing. Processing includes, but is not limited to, bleeding, washing, trimming, and cleaning.

Most of the process is automated and performed by machine. For example, after chickens are bled and washed, they are passed through a plucking machine. The shackled chickens are carried through the plucking machine via the conveyor line. Upon their exit, they are stripped of most, if not all, of their feathers.

Some processing requires human workers to process the chickens while the chickens move along the assembly line. Employees sit or stand on each side of the line and handle and process the chickens as they pass. For example, the wing tips of chickens are cut off by workers located along the assembly line using clippers.

The areas of the assembly line requiring human intervention to physically process the chickens tend to be the most costly and volume limiting. In kosher processing, chickens are covered inside and out with kosher salt. Historically, this salting was performed by hand. This requires workers to salt the body cavities, neck skin and exterior of each chicken on the line. This hand processing is laborious, time consuming, and inefficient. Furthermore, it is wasteful of salt.

### SUMMARY

The systems and methods described herein relate to automatically seasoning meat. In particular, the systems include a seasoning dispenser positioned over a moving conveyor. The conveyor is coupled to a partially perforated drum having agitator structures. The rotatable drum is coupled with a seasoning collector and a return conveyor, which in turn is coupled back to the seasoning dispenser. During operation, the seasoning dispenser dispenses seasoning into the cavities of meat that are disposed along the conveyor. The seasoning-filled meat falls into the rotatable drum and tumbles about while striking the agitator structures and the walls of the drum, thereby distributing the seasoning across interior and exterior surfaces of the meat. Excess seasoning is collected through the perforations in the drum by the seasoning collector and returned to the seasoning dispenser by the return conveyor for re-use.

For purposes of clarity, and not by way of limitation, the systems and methods may be described herein in the context of the automatic seasoning of poultry. However, it may be understood that the systems and methods described herein may be applied to provide for the automatic seasoning of other food products. For example, the systems and methods of the invention may be used to season beef, pork, vegetables, or other raw and/or prepared foods.

According to one aspect of the invention, a system for automatically seasoning poultry is provided. The system includes a first seasoning assembly and a rotatable drum. The first seasoning assembly includes a conveyor mechanism, a plurality of support structures configured to support poultry carcasses, and a seasoning dispenser configured to deposit seasoning into a cavity of a poultry carcass. The plurality of support structures extend from and are positioned along a length of the conveyor mechanism. The rotatable drum has a sealed side wall portion and a perforated side wall portion. The rotatable drum receives the poultry carcasses with deposited seasoning from the first seasoning assembly, coats at least a portion of an exterior surface of the poultry carcasses with a first portion of the seasoning, and removes a second portion of the seasoning.

In some embodiments, the rotatable drum includes at least one agitator structure disposed on an interior surface of the drum. The agitator structure may include at least one flexible finger for distributing seasoning on the exterior surface of a poultry carcass. Optionally, the agitator structure extends along the interior surface of the drum and along at least a portion of the sealed side wall portion. In certain embodiments, the agitator structure includes a base support with a V-shaped cross-section and an intermediate support, having the at least one flexible finger, attached near the apex of the base support. In some embodiments, the rotatable drum has a plurality of agitator structures, and optionally, the rotatable drum has three agitator structures substantially equally spaced apart in the drum.

In certain embodiments, the conveyor mechanism includes a conveyor belt and the plurality of support structures includes a plurality of support posts positioned at intervals along the length of the conveyor belt. In some embodiments, the system includes a seasoning collector mechanism that removes the second portion of the seasoning. Optionally, the system includes a recirculation conveyor mechanism that provides the removed second portion of the seasoning to the seasoning mechanism.

In another aspect of the invention, a system for automatically seasoning poultry is disclosed. The system includes an inlet feed for receiving poultry to be seasoned, an outlet for discharging seasoned poultry, and a rotatable drum positioned in between the inlet feed and the outlet. The rotatable drum has a sealed side wall portion that extends away from the inlet feed, a perforated side wall portion near the outlet, and one or more agitator structures extending along the sealed side wall portion.

In some embodiments, the agitator structures each include a support member and at least one flexible finger for distributing seasoning on at least a portion of the exterior surface of a chicken carcass. Optionally, the support member has a V-shaped cross-section and a plate positioned near the apex of the support member, and the flexible finger or fingers extend from the plate. In certain embodiments, the rotatable drum includes a plurality of agitator structures, and in some embodiments, the drum includes three agitator structures substantially equally spaced apart in the rotatable drum.

In yet another aspect of the invention, a method for seasoning poultry is disclosed. The method includes disposing a first poultry carcass on a support structure extending from a conveyor mechanism. Seasoning is deposited within an internal cavity of the first carcass to coat at least a portion of the carcass interior surface. The first carcass is tumbled in a rotatable drum such that a first portion of the seasoning within the cavity is distributed on at least a part of the exterior surface of the first carcass. A second portion of the seasoning is collected for depositing on a second poultry carcass.

In some embodiments, the support structure may be a support post that supports the first poultry carcass through the internal cavity of the carcass. Optionally, at least some of the first portion of seasoning is distributed on the carcass exterior surface by one or more agitator structures disposed within the rotatable drum.

In yet another aspect of the invention, a system for automatically seasoning poultry is disclosed. The system includes a first seasoning means for dispensing seasoning into one or more cavities of at least one of a plurality of poultry carcasses. The system also includes a first distributing means for coating at least a portion of an exterior surface of at least one of the poultry carcasses and removing excess seasoning from the cavity or cavities of at least one of the poultry carcasses.

In some embodiments, the first seasoning means may include a first conveying means for conveying the plurality of poultry carcasses, a first supporting means for supporting at least one of the poultry carcasses, and/or a first dispensing means for dispensing seasoning into one or more cavities of at least one of the poultry carcasses. In certain embodiments, the first distributing means may include a first tumbling means for tumbling at least one of the poultry carcasses to coat at least a portion of the exterior surface of at least one of the poultry carcasses. The first distributing means may also include a first agitating means for agitating at least one of the poultry carcasses to coat at least a portion of the exterior surface. Optionally, the first distributing means may include a filtering means for filtering excess seasoning from the one or more cavities of at least one of the poultry carcasses, a collector means for collecting filtered excess seasoning, and/or a recirculating means for recirculating the filtered excess seasoning to the first seasoning means.

### BRIEF DESCRIPTION OF THE FIGURES

The foregoing and other objects and advantages of the invention will be appreciated more fully from the following further description thereof, with reference to the accompanying drawings wherein:

FIG. 1 depicts a block diagram of a poultry processing assembly line according to an illustrative embodiment of the invention;

FIG. 2 depicts an automated seasoning system according to an illustrative embodiment of the invention;

FIGS. 3A-B depict a seasoning dispenser of the automated seasoning system shown in FIG. 2, according to an illustrative embodiment of the invention;

FIGS. 3C-E depict various support structures, according to illustrative embodiments of the invention;

FIGS. 4A-C depict a rotatable drum component of the automated seasoning system shown in FIG. 2, according to an illustrative embodiment of the invention;

FIG. 5A-C depict agitator structures in the rotatable drum shown in FIG. 4A, according to illustrative embodiments of the invention; and

FIG. 6 is a flowchart depicting an illustrative process for seasoning poultry, according to an embodiment of the invention.

### DETAILED DESCRIPTION

To provide an overall understanding of the invention, certain illustrative embodiments will now be described, including systems and methods for seasoning meat. The following illustrative embodiments are described with respect to employing the systems and methods of the invention for automatically seasoning poultry during kosher poultry processing. However, the systems and methods of the invention may be used to coat any suitable sample with any suitable seasoning.

The systems and methods described herein relate to automatically seasoning meat. In particular, the systems include a seasoning dispenser positioned over a moving conveyor. The conveyor is coupled to a partially perforated drum having agitator structures. The rotatable drum is coupled with a seasoning collector and a return conveyor, which in turn is coupled back to the seasoning dispenser. During operation, the seasoning dispenser dispenses seasoning into the cavities of meat that are disposed along the conveyor. The seasoning-filled meat falls into the rotatable drum and tumbles about while striking the agitator structures and the walls of the drum, thereby distributing the seasoning across interior and exterior surfaces of the meat. Excess seasoning is collected through the perforations in the drum by the seasoning collector and returned to the seasoning dispenser by the return conveyor for re-use.

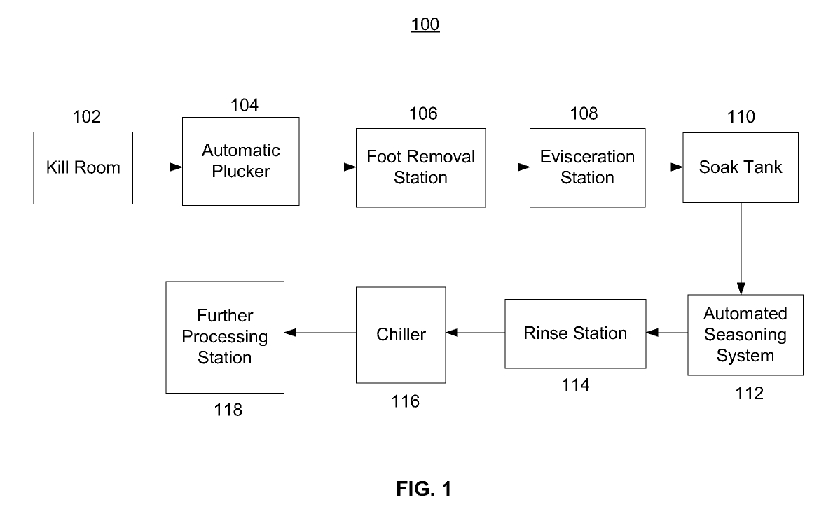

FIG. 1 is a conceptual diagram of a kosher poultry processing assembly line 100 including an automated seasoning system 112 according to an illustrative embodiment of the invention. The assembly line 100 may include kill room 102, automatic plucker 104, foot removal station 106, evisceration station 108, soak tank 110, automated seasoning system 112, rinse station 114, chiller 116, and a further processing station 118.

The kill room 102 receives chickens and hang them upside down in shackles on a conveyor line. Their throats are then cut in accordance with rabbinic practices, and they are allowed to bleed-out. Subsequent to the bleed-out in the kill room 102, the chicken carcasses travel via the conveyor line to an automatic plucker 104. The automatic plucker 104 includes two walls with rotating discs affixed thereto. Finger-like extensions are affixed to rotating discs. The finger-like extensions disposed on the rotating discs strip the feathers off the chicken carcasses between the two walls of the automated plucker wall 104.

The chicken carcasses then pass into a foot removal station 106. At the foot removal station 106, the chicken carcasses are removed from the shackles and their feet are amputated by hand. Subsequently, the chicken carcasses pass to an evisceration station 108. At the evisceration station 108, the internal organs of the chicken carcasses are removed from one or more natural or artificial orifices to form internal cavities. Eviscerated carcasses then travel to the soak tank 110.

In the soak tank 110, the carcasses are soaked in water, in accordance with rabbinic practices. Soaking chicken carcasses in water causes the water to diffuse and displace any blood that may be contained in carcass meat. After the chicken carcasses soak for a predetermined period of time in accordance with rabbinic standards, they are placed on a conveyor and pass to the automated seasoning system 112 of the invention.

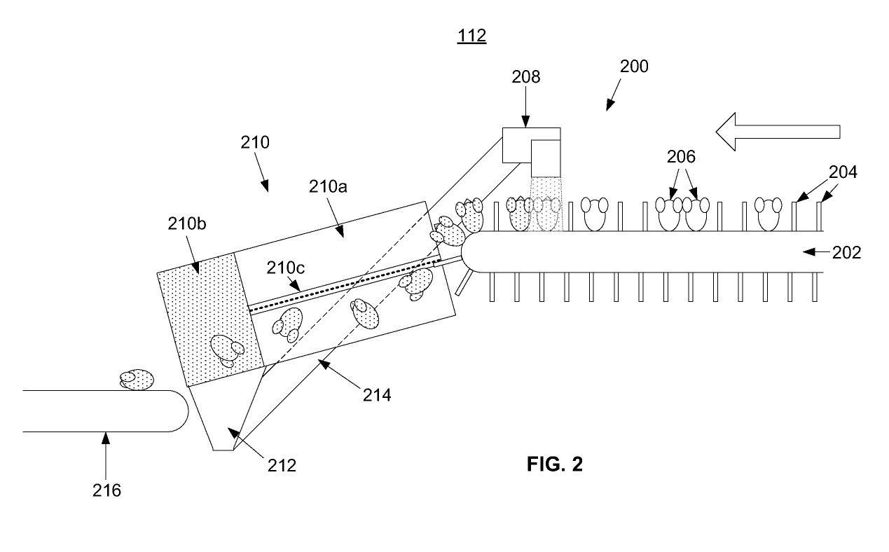

Automated seasoning system 112 deposits seasonings onto the poultry. Specifically, the automated seasoning system may apply salt to the interior and exterior surfaces of the poultry. The salting removes the remaining blood cells that may be left within the carcass meat and kills any bacteria, such as salmonella. Conventionally, this process is done by hand, wherein workers stuff salt into the cavity of each chicken carcass. The automated seasoning system 112 of the invention is discussed in more detail below with respect to FIGS. 2-5.

When the chicken carcasses exit the automated seasoning system 112, they may be removed from the conveyor and placed onto a slow moving conveyor belt (not shown). The chicken carcasses remain on the slow conveyor belt for a predetermined period of time (e.g., approximately one hour). This predetermined period of time accords with rabbinic standards. The chicken carcasses then pass to the rinse station 114.

Salted chicken carcasses are triple rinsed in rinse station 114 then pass on to chilling chamber 116, wherein the chicken carcasses are chilled to a predetermined temperature. The chilled chicken carcasses pass to further processing station 118. Further processing station 118 can include, for example, rendering the chicken carcasses into separate parts and/or packaging them for delivery.

FIG. 2 depicts automated seasoning system 112 according to an illustrative embodiment of the invention. Automated seasoning system 112 may include a first seasoning assembly 200 and a rotatable drum 210. The first seasoning assembly 200 may include a conveyor mechanism 202, a plurality of support structures 204 attached to conveyor mechanism 202, and a seasoning dispenser 208. In some embodiments, the support structures 204 may be configured to receive one or more eviscerated chicken carcasses 206. Conveyor mechanism 202 may be configured to convey chicken carcasses 206 mounted on support structures 204 in the direction indicated by the block arrow. In some embodiments, conveyor mechanism 202 may be a conveyor belt, with the top of the conveyor belt configured to move in the direction indicated by the block arrow. Supports 204 may include support posts upon which the eviscerated chicken carcasses 206 are placed. For example, an eviscerated chicken carcass may be placed upon a support post such that the support post supports the chicken carcass through its internal body cavity.

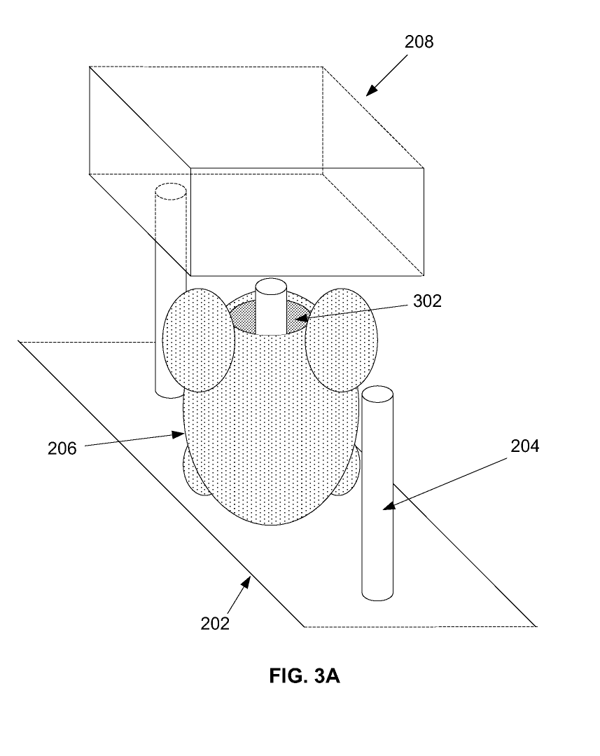

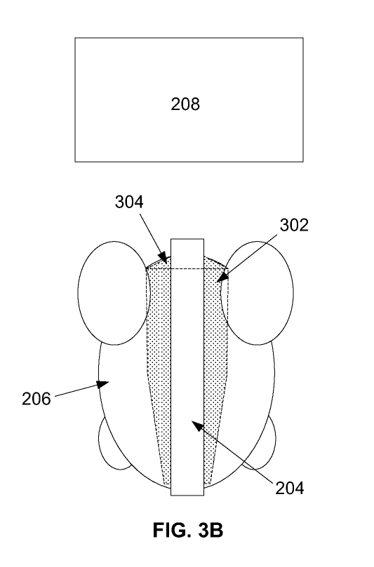

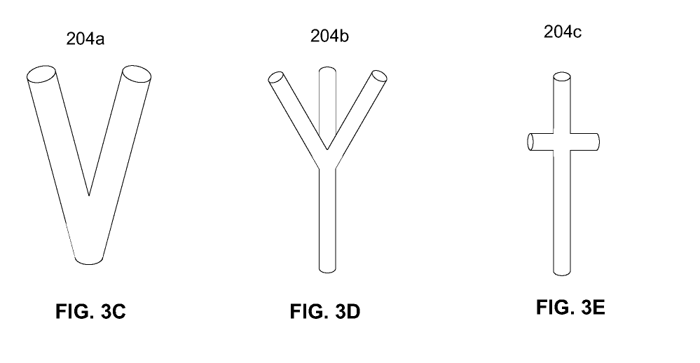

Seasoning dispenser 208 may be configured to dispense at least one type of seasoning on chicken carcasses 206. In some embodiments, the seasoning may include salt. In certain embodiments, seasoning dispenser 208 may be configured to dispense seasoning into an internal cavity of a chicken carcass via at least one orifice. Optionally, seasoning dispenser 208 may be configured to also dispense seasoning onto at least one exterior surface of a chicken carcass, or even onto the portions of conveyor mechanism 202 adjacent to the chicken carcass. Conveyor mechanism 202 may convey the chicken carcasses 206 to be seasoned by seasoning dispenser 208. Seasoning dispenser 208 and support structures 204 are described in further detail in relation to FIGS. 3A-E.

After chicken carcasses 206 are seasoned by seasoning dispenser 208, conveyor mechanism 202 of the first seasoning assembly 200 may convey the chicken carcasses 206 to rotatable drum 210 and deposit the chicken carcasses 206 into the rotatable drum 210. In certain embodiments, the conveyor mechanism 202 may deposit chicken carcasses 206 into rotatable drum 210 by inverting the orientation of support structures 204 mounted on the conveyor mechanism 202. For example, if support structures 204 include support posts upon which chicken carcasses 206 are placed, the conveyor mechanism 202 may tilt and gradually invert the support posts such that chicken carcasses 206 placed on the support posts will slide off into the rotatable drum 210. In other embodiments, the conveyor mechanism 202 may deposit the chicken carcasses 206 onto an intermediate inlet conveyor (not shown) that then deposits the chicken carcasses 206 into the rotatable drum 210. For example, the conveyor mechanism 202 may deposit chicken carcasses 206 onto a tilted ramp, which causes the chicken carcasses 206 to slide into rotatable drum 210. First seasoning assembly 200 is one example of means for dispensing seasoning into one or more cavities of one or more chicken carcasses.

Rotatable drum 210 may be configured to distribute the seasoning dispensed by seasoning dispenser 208 onto chicken carcasses 206 by, for example, rotating in order to tumble chicken carcasses 206 placed within the drum about. Rotatable drum 210 may include a first drum portion 210a with a sealed sidewall and a second drum portion 210b with a perforated sidewall. Optionally, rotatable drum 210 may also include at least one agitator structure 210c to assist in the distribution of seasoning.

In certain embodiments, rotatable drum 210 may be oriented at a slight angle with respect to the horizontal, such that chicken carcasses deposited within the rotating drum incrementally move to one end of the drum as they tumble. For example, the drum may be adjustably oriented with the second drum portion 210b somewhat lower than the first drum portion 210a, such that chicken carcasses within the rotating drum move toward the second drum portion 210b. The orientation angle of the rotatable drum 210 with respect to the horizontal may range from about five degrees to about 45 degrees, and the orientation angle may be changed dynamically, for example by adjusting drum support. A chicken carcass deposited in rotatable drum 210 from conveyor 202 may first be tumbled in first drum portion 210a and agitated by the at least one agitator structure 210c in order to distribute seasoning across the various surfaces of the chicken carcass. During the seasoning distribution process, while a significant portion of the seasoning deposited within the internal cavity of the chicken carcass will remain adhered to the internal surfaces of the cavity, excess seasoning within the internal cavity may escape from the cavity into the rotatable drum and be distributed onto the external surfaces of the chicken carcass by the drum sidewall and the at least one agitator structure 210c. As the chicken carcass tumbles, it may move toward the lower end of the rotatable drum as a result of gravity. When the chicken carcass reaches the second drum portion 210b with perforated sidewalls, excess seasoning may escape through the perforations of the sidewall and land in seasoning collector 212. Excess seasoning collected by the seasoning collector 212 may be processed to remove contaminants or seasoning lumps, and may be recirculated to seasoning dispenser 208 via a recirculating conveyor 214. Excess seasoning may be processed by, for example, agitated sifting through a sifter or filter apparatus. Recirculating conveyor 214 may include a screw conveyor, or may be any other conveyor mechanism capable of moving material from the seasoning collector 212 to the seasoning dispenser 208. Rotatable drum 210, agitator structures 210c, seasoning collector 212, and recirculating conveyor 214 together are one example of means for coating part of an exterior surface of one or more chicken carcasses with seasoning and removing excess seasoning from the cavity or cavities of the poultry carcasses. The second drum portion 210b with perforated side walls is an example of means for filtering excess seasoning from the cavities of the poultry carcasses. Seasoning collector 212 is an example of means for collecting filtered excess seasoning. The recirculating conveyor 214 is an example of means for recirculating filtered excess seasoning.

After a chicken carcass has passed through the second drum portion 210b, the seasoned chicken carcass may be deposited on an outlet conveyor 216, which may convey the seasoned chicken carcass to the next processing stage.

The rotating drum 210, conveyor mechanism 202, seasoning dispenser 208, recirculating conveyor 214, and/or the outlet conveyor 216 may be driven by one or more motors (not shown). In some embodiments, each element to be driven may be driven by an individual motor. In other embodiments, one motor may drive one or more of the above elements.

FIG. 3A depicts the seasoning dispenser 208 of the automated seasoning system shown in FIG. 2, according to an illustrative embodiment of the invention. Also depicted are a portion of conveyor mechanism 202, support structures 204, and a chicken carcass 206 mounted on one of the support structures 204. Seasoning dispenser 208 may be positioned above the conveyor mechanism 202 in order to dispense seasoning onto or into chicken carcass 206. The seasoning dispenser 208 may be positioned above the conveyor mechanism at a height of between about 3 inches to 36 inches, or even higher. In some embodiments, seasoning dispenser 208 may be configured to dispense seasoning into a first internal cavity 302 of chicken carcass 206. The first internal cavity 302 of chicken carcass 206 may result from evisceration of the chicken carcass at evisceration station 108, shown in FIG. 1. In certain embodiments, seasoning dispenser 208 may include a seasoning chute, by which seasoning is deposited and/or dispensed on chicken carcass 206 or into first internal cavity 302. In other embodiments, seasoning dispenser 208 may include other dispensing mechanisms, such as a seasoning shaker, a seasoning tube, or any other suitable dispensing mechanism. Seasoning dispenser 208 may be configured to dispense seasoning onto the exterior surface and/or into the interior cavity of a single supported chicken carcass, or may be configured to dispense seasoning onto/into multiple supported chicken carcasses. For example, the dispensing mechanism of seasoning dispenser 208 may be configured to dispense seasoning onto/into two, three, or even more adjacent supported chicken carcasses. In these embodiments, the position of the dispenser 208 and/or the height of the dispenser 208 above the conveyor mechanism 202 and/or the support structures 204 may be selected to dispense seasoning into the cavities of or onto one or more supported chicken carcasses. Seasoning dispenser 208 is one example of means for dispensing seasoning into one or more cavities of at least one poultry carcass.

Support structures 204 may be mounted on the conveyor mechanism 202 such that they extend substantially perpendicularly to a surface of the conveyor mechanism 202. For example, if the conveyor mechanism includes a conveyor belt, the support structures 204 may be mounted on the conveyor belt such that they extend substantially perpendicularly to the surface of the conveyor belt. In other embodiments, the support structures 204 may be mounted at an angle to the surface of the conveyor belt, ranging from about zero degrees from the normal of the conveyor surface to about 45 degrees from the normal of the conveyor surface. Conveyor mechanism 202 is one example of means for conveying poultry carcasses.

Support structures 204 may be mounted on the conveyor mechanism 202 to maintain a spacing between individual support structures. This spacing may be uniform for all the support structures 204. In some embodiments, the spacing may range from about 4 inches to about 16 inches. Optionally, the support structures 204 may be spaced such that a chicken carcass mounted on a support structure does not come into contact with chicken carcasses mounted on adjacent support structures. Alternatively, the support structures 204 may be spaced such that chicken carcasses mounted on adjacent support structures do have at least some contact with each other. The height of each of the support structures 204 may range from about 2 inches to about 16 inches. In some embodiments, the height of each of the support structures 204 substantially matches the length of a chicken carcass cavity. In other embodiments, the height of each support structure 204 may be shorter than the length of a chicken carcass cavity, or may be longer than the length of a chicken carcass cavity. The height of each support structure 204 may be shorter than the distance from the bottom of the seasoning dispenser 208 to the top of the conveyor mechanism 202. Support structures 204 may have circular cross-sections, with diameters ranging from about a half inch to two inches. In other embodiments, the cross-sections of support structures 204 may be other shapes, such as squares, triangles, rectangles, ellipses, or any other suitable shape. Support structures 204 may be made of metal, plastic, or any suitable material. Support structures 204 are one example of means for supporting at least one poultry carcass.

FIG. 3B depicts another view of seasoning dispenser 208, including a cutaway view of chicken carcass 206 showing support structure 204, first internal cavity 302, and dispensed seasoning 304. In certain embodiments, seasoning dispenser 208 dispenses enough seasoning 304 to entirely fill the first internal cavity 302 of chicken carcass 206. This may ensure that the entire internal surface of first internal cavity 302 is coated with seasoning. In other embodiments, seasoning dispenser 208 may dispense enough seasoning to partially fill the first internal cavity 302 of chicken carcass 206. Optionally, the seasoning dispenser 208 may also dispense seasoning on the external surface of chicken carcass 206.

FIGS. 3C-E depict various support structures 204a-c, according to illustrative embodiments of the invention. FIG. 3C depicts a support structure 204a for holding a chicken carcass internal cavity open to facilitate seasoning of the interior cavity. The junction between the two branching posts may be disposed near the bottom of the support structure 204a, as shown, or may be disposed anywhere along the height of the support structure, as shown by support structure 204b in FIG. 3D. Moreover, there may be any number of branching posts from a particular junction in the support structure 204. For example, support structure 204b includes three branching posts. The angle between the branching posts of support structure 204 may be selected to keep a chicken carcass internal cavity open without stretching the walls of the cavity, and may range from about 5 degrees to about 90 degrees, as shown by support structure 204c in FIG. 3E. Support structures 204a-c are examples of means for supporting poultry carcasses.

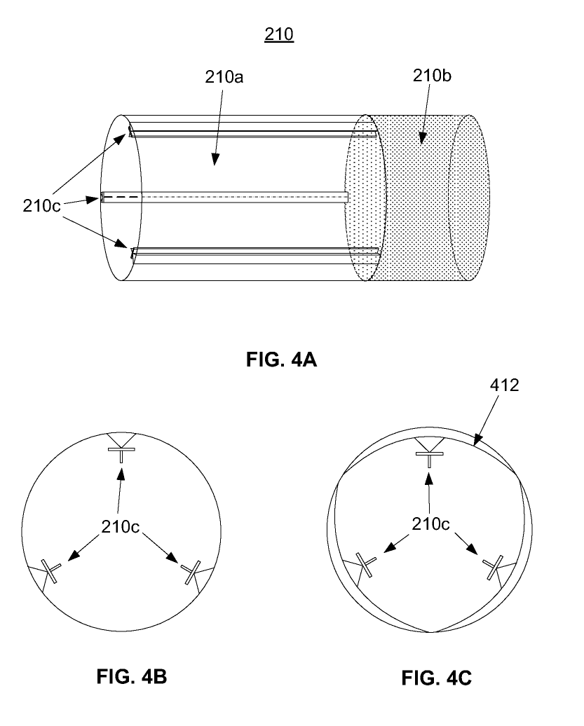

FIG. 4A-C depict the rotatable drum 210 of the automated seasoning system shown in FIG. 2, according to an illustrative embodiment of the invention. FIG. 4A depicts a first cross-section of rotatable drum 210, taken along a longitudinal axis of the rotatable drum 210. In the depicted embodiment, the first cross-section is rectangular, but in other embodiments, the first cross-section may have a different shape, such as a trapezoid. Rotatable drum 210 may include a first drum portion 210a, a second drum portion 210b, and at least one agitator structure 210c. In certain embodiments, first drum portion 210a may include a sealed sidewall, and second drum portion 210b may include a perforated sidewall. First drum portion 210a may occupy a longer proportion of the length of rotatable drum 210 than second drum portion 210b. In some embodiments, first drum portion 210a may occupy about two-thirds of the length of rotatable drum 210 and second drum portion 210b may occupy about one-third of the length of rotatable drum 210. In other embodiments, first drum portion 210a may occupy from about half of the length of rotatable drum 210 to about five-sixths of the length of rotatable drum 210, and second drum portion 210b may occupy from about one-sixth of the length of rotatable drum 210 to about half of the length of rotatable drum 210. In some embodiments, the rotatable drum may have a length ranging from about 36 inches to about 120 inches, and an outer diameter ranging from about 18 inches to about 72 inches. Rotatable drum 210 is an example of means for tumbling chicken carcasses to coat at least a portion of the exterior surface of at least one chicken carcass.

Rotatable drum 210 may include one or more agitator structures 210c. In the embodiment depicted in FIGS. 4A-C, rotatable drum 210 includes three agitator structures 210c, but in other embodiments rotatable drum 210 may include two, four, or even more agitator structures. Optionally, the plurality of agitator structures 210c may be positioned equidistant from each other. In other embodiments, the spacing between each of the plurality of agitator structures 210c may vary. In some embodiments, the agitator structures 210c may include rib members that extend along the length of the first drum portion 210a, as shown in FIG. 4A. In other embodiments, the agitator structures 210c may extend at least partially into the second drum portion 210b. Alternatively, the agitator structures 210c may include agitator members that do not extend along the entire length of the first drum portion 210a. For example, multiple agitator members may be positioned along the length of the first drum portion 210a and/or the second drum portion 210b. Agitator structures 210c are examples of means for agitating poultry carcasses to coat at least a portion of the exterior surface of one of the poultry carcasses.

FIG. 4B depicts a second cross-section of rotatable drum 210, showing the drum sidewall. In the embodiment depicted, the second cross-section is circular, but in other embodiments, the second cross-section may be shaped like a square, an ellipse, or any other suitable shape. The agitator structures 210c may be mounted directly upon the rotatable drum sidewall. In another embodiment, shown in FIG. 4C, while the exterior surface cross-section of rotatable drum 210 may be circular, the interior surface cross-section 412 may be shaped differently. For example, the interior cross-section 412 may be a polygon with straight and/or curved sides. In other embodiments, the exterior surface cross-section of rotatable drum 210 may be any other suitable shape, such as square, pentagonal, hexagonal, or any other suitable shape.

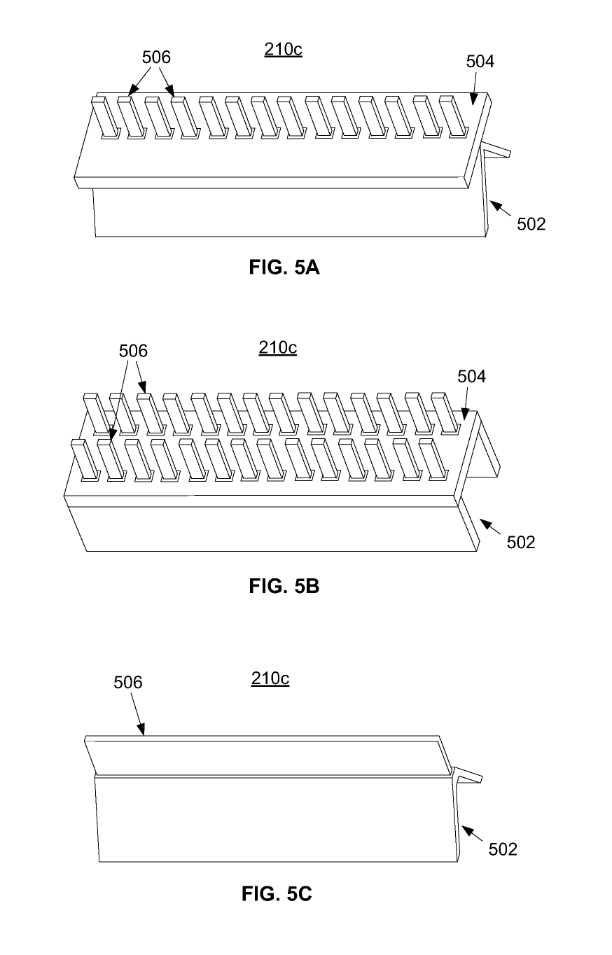

FIG. 5A-C depict various embodiments of the agitator structure 210c disposed within the rotatable drum 210 shown in FIG. 4A, according to illustrative embodiments of the invention. Agitator structure 210c may be used to distribute seasoning onto internal and external surfaces of chicken carcasses. In some embodiments, agitator structure 210c may assist in manipulating attached portions of the chicken carcass, such as the thighs or the wings, in order to more evenly distribute seasoning across the entire external surface of the chicken carcass. Agitator structure 210c includes a base support 502. Base support 502 may be configured to be attached to an internal surface of rotatable drum 210, as depicted in FIGS. 4A-C, and may be attached to the internal surface via any suitable means. In certain embodiments, depicted in FIGS. 5A and 5C, base support 502 has a triangular or V-shaped hollow cross-section. Alternatively, the cross-section of base support 502 may be any other suitable shape, and may be solid. For example, the cross-section of base support 502 may be rectangular, as depicted in FIG. 5B. Base support 502 may have a maximum height of between about one-eighth of an inch to about eight inches, a maximum width of about half an inch to about six inches, and a length of about half an inch to about 108 inches. In some embodiments, such as those shown in FIGS. 5A-B, agitator structure 210c may include an intermediate support 504 attached to base support 502. Intermediate support 504 may provide a surface to which at least one agitator 506 may be attached. In some embodiments, intermediate support 504 may be attached to base support 502 near its apex. In other embodiments, agitators 506 may be directly attached to base support 502, or directly attached to the rotatable drum sidewall. For example, in the embodiment depicted in FIG. 5C, agitator 506 is directly attached to base support 502.

In some embodiments, the agitator 506 may be a finger, member, or flap configured to agitate a chicken carcass in rotatable drum 210. The agitator 506 may be made of a flexible material, such as rubber or other polymeric material. In some embodiments, such as the embodiment depicted in FIG. 5C, the agitator 506 may be a monolithic structure. Alternatively, the agitator 506 may include multiple strands or smaller fingers. In one embodiment, multiple agitators 506 may be attached to intermediate support 504 or base support 502 along a center line, as depicted in FIG. 5. Optionally, multiple agitators may be attached anywhere on intermediate support 504 or base support 502. In some embodiments, multiple agitators 506 may be attached in two or more rows, as shown in FIG. 5B. Individual agitators 506 in any of the above embodiments may have heights ranging from about half an inch to about 12 inches, widths or diameters ranging from about one-sixteenth of an inch to about 2 inches, and lengths ranging from about one-sixteenth of an inch to about 72 inches. In some embodiments, individual agitators 506 may include a plurality of strands, with strand diameters of about 0.25 inches to about 2 inches. The agitator structures shown in FIGS. 5A-C are examples of means for agitating poultry carcasses to coat at least a portion of the exterior surface of one of the poultry carcasses.

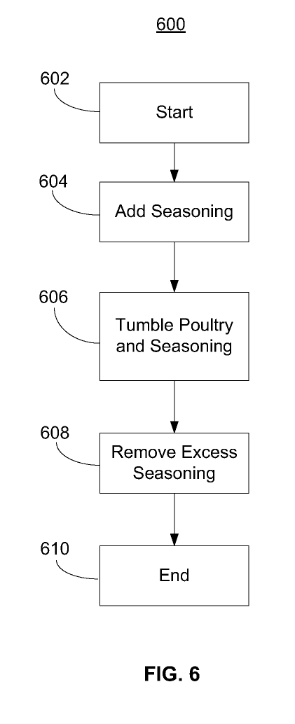

FIG. 6 is a flowchart depicting an illustrative process 600 for seasoning poultry, according to an embodiment of the invention. In step 602, a chicken carcass is received from the previous stage in the poultry processing assembly line, such as soak tank 110, discussed in relation to FIG. 1.

In step 604, seasoning is added to the chicken carcass. For example, seasoning dispenser 208 may add seasoning to the chicken carcass. In some embodiments, the seasoning is salt, and the seasoning is added such that a significant portion of the seasoning is added to an internal cavity of the chicken carcass. Optionally, enough seasoning may be added to the internal cavity of the chicken carcass to substantially cover all of the internal surface of the cavity. In some embodiments, seasoning may also be added to the exterior surface of the chicken carcass.

In step 606, the chicken carcass and seasoning may be tumbled in, for example, rotatable drum 210, in order to distribute the seasoning evenly across the internal and external surfaces of the chicken carcass. Excess seasoning in the internal cavity of the chicken carcass not adhered to an internal chicken surface may escape from the cavity during the tumbling process and be distributed onto an external surface of the chicken carcass.

In step 608, any excess seasoning that has not adhered to an internal or external surface of a chicken carcass may be removed from the chicken carcass. This may be done by, for example, a second drum portion with a perforated sidewall, as described in relation to FIG. 2 and FIG. 4A. As the chicken carcass tumbles, excess seasoning may fall through the perforations in the sidewall. In certain embodiments, the excess seasoning may be collected by, for example, a seasoning collector, such as seasoning collector 212, described in relation to FIG. 2, and then redistributed on other chicken carcasses.

After the excess seasoning removal step 608, the chicken carcass may pass to the next processing stage at step 610.

Variations, modifications, and other implementations of what is described may be employed without departing from the spirit and scope of the invention. More specifically, any of the method and system features described above or incorporated by reference may be combined with any other suitable method or system feature disclosed herein or incorporated by reference, and is within the scope of the contemplated inventions. The systems and methods may be embodied in other specific forms without departing from the spirit or essential characteristics thereof. The foregoing embodiments are therefore to be considered in all respects illustrative, rather than limiting of the invention. The teachings of all references cited herein are hereby incorporated by reference in their entirety.

1. A system for automatically seasoning poultry, comprising:
a first seasoning assembly, having
a conveyor mechanism,
a plurality of support structures positioned along a length of the conveyor mechanism, wherein the support structures extend from the conveyor mechanism and are configured to support a plurality of poultry carcasses, and
a seasoning dispenser configured to deposit seasoning into one or more cavities of one or more of the plurality of poultry carcasses; and
a rotatable drum, having a sealed side wall portion and a perforated side wall portion;
wherein the rotatable drum receives one or more of the plurality of poultry carcasses and seasoning from the first seasoning assembly, coats at least a portion of an exterior surface of the poultry carcass with a first portion of the seasoning, and removes a second portion of the seasoning.

2. The system of claim 1, wherein the rotatable drum includes at least one agitator structure disposed on an interior surface of the rotatable drum.

3. The system of claim 2, wherein the at least one agitator structure includes at least one flexible finger, for distributing seasoning on at least a portion of the exterior surface of the poultry carcass.

4. The system of claim 2, wherein the at least one agitator structure extends along the interior surface and along at least a portion of the sealed side wall portion.

5. The system of claim 4, wherein the at least one agitator structure includes a base support having a V-shaped cross-section and an intermediate support having the at least one flexible finger, the intermediate support attached near the apex of the base support.

6. The system of claim 3, wherein the rotatable drum includes a plurality of agitator structures.

7. The system of claim 6, wherein the rotatable drum includes three agitator structures substantially equally spaced apart in the rotatable drum.

8. The system of claim 1, wherein
the conveyor mechanism includes a conveyor belt,
the plurality of support structures includes a plurality of support posts, and
the plurality of support posts are positioned at intervals along the length of the conveyor belt.

9. The system of claim 1, further comprising a seasoning collector mechanism and a recirculation conveyor mechanism, wherein the second portion of seasoning is removed to the seasoning collector mechanism and provided to the seasoning mechanism by the recirculation conveyor mechanism.

10. A system for automatically seasoning poultry, comprising
an inlet feed for receiving poultry carcasses to be seasoned;
an outlet for discharging seasoned poultry carcasses; and
a rotatable drum positioned in between the inlet feed and the outlet, comprising:
a sealed side wall portion extending away from the inlet feed,
a perforated side wall portion near the outlet, and
one or more agitator structures extending along the sealed side wall portion.

11. The system of claim 10, wherein the agitator structures each include a support member and at least one flexible finger for distributing seasoning on at least a portion of the exterior surface of a poultry carcass.

12. The system of claim 11, wherein the support member has a V-shaped cross-section and a plate positioned near the apex of the support member, and the at least one flexible finger extends from the plate.

13. The system of claim 10, wherein the rotatable drum includes a plurality of agitator structures.

14. The system of claim 10, wherein the rotatable drum includes three agitator structures substantially equally spaced apart in the rotatable drum.

15. A method for seasoning poultry, comprising:
disposing a first poultry carcass on a support structure extending from a conveyor mechanism;
depositing seasoning within an internal cavity of the first poultry carcass to coat at least a portion of an interior surface of the first poultry carcass;
tumbling the first poultry carcass such that a first portion of the seasoning within the internal cavity is distributed on at least a portion of an exterior surface of the first poultry carcass; and
collecting a second portion of the seasoning for depositing on a second poultry carcass.

16. The method of claim 15, wherein the support structure is a support post, and the support post supports the first poultry carcass through the internal cavity of the first poultry carcass.

17. The method of claim 15, wherein at least a portion of the first portion of the seasoning is distributed on the exterior surface by at least one agitator structure disposed within the rotatable drum.

18. A system for automatically seasoning poultry, comprising
a first seasoning means for dispensing seasoning into one or more cavities of at least one of a plurality of poultry carcasses; and
a first distributing means for coating at least a portion of an exterior surface of at least one of the poultry carcasses with seasoning and removing excess seasoning from the one or more cavities of at least one of the poultry carcasses.

19. The system of claim 18, wherein the first seasoning means comprises a first conveying means for conveying the plurality of poultry carcasses.

20. The system of claim 18, wherein the first seasoning means comprises a first supporting means for supporting at least one of the poultry carcasses.

21. The system of claim 18, wherein the first seasoning means comprises a first dispensing means for dispensing seasoning into one or more cavities of at least one of the poultry carcasses.

22. The system of claim 18, wherein the first distributing means comprises a first tumbling means for tumbling at least one of the poultry carcasses to coat at least a portion of the exterior surface.

23. The system of claim 18, wherein the first distributing means comprises a first agitating means for agitating at least one of the poultry carcasses to coat at least a portion of the exterior surface.

24. The system of claim 18, wherein the first distributing means comprises:
a filtering means for filtering excess seasoning from the one or more cavities of at least one of the poultry carcasses;
a collector means for collecting the filtered excess seasoning; and
a recirculating means for recirculating the filtered excess seasoning to the first seasoning means.
